(19) United States
(12) Patent Application Publication
(10) Pub. No.: US 2019/0152142 A1
(43) Pub. Date: May 23, 2019

(54) THREE-DIMENSIONAL PRINTING APPARATUS

(71) Applicant: Roland DG Corporation, Hamamatsu-shi (JP)

(72) Inventor: Yoichiro OGAWA, Hamamatsu-shi (JP)

(21) Appl. No.: 16/185,039

(22) Filed: Nov. 9, 2018

(30) Foreign Application Priority Data
Nov. 22, 2017 (JP) 2017-224707

(51) Int. Cl. B29C 64/214; B29C 64/245; B33Y 30/00

(52) U.S. Cl. CPC B29C 64/214; B33Y 30/00; B29C 64/245

(57) ABSTRACT

A three-dimensional printing apparatus includes a re-coater including a leveler that levels off a powder material, a powder spread guide including a contact surface that contacts with the powder material, and a transfer device that transfers the re-coater and the powder spread guide in a first direction. The transfer device retains the powder spread guide so that a lower end of the contact surface of the powder spread guide is kept at a height lower than the powder material on a feed region, the contact surface is disposed forward along the first direction relative to the leveler, and at least a portion of the contact surface passes outside a build region with respect to a second direction perpendicular or substantially perpendicular the first direction. In transferring the powder spread guide, the contact surface transfers at least a portion of the powder material that contacts with the contact surface to an inside of the build region.

### CROSS REFERENCE TO RELATED APPLICATIONS

This application claims the benefit of priority to Japanese Patent Application No. 2017-224707 filed on Nov. 22, 2017. The entire contents of this application are hereby incorporated herein by reference.

### BACKGROUND OF THE INVENTION

### 1. Field of the Invention

The present invention relates to a three-dimensional printing apparatus.

### 2. Description of the Related Art

A powder bed additive manufacturing technique, as disclosed in Japanese Patent No. 5400042B, is conventionally known, in which a powder material is solidified by a binder ejected onto the powder material to shape a desired three-dimensional object.

The three-dimensional printing apparatus disclosed in Japanese Patent No. 5400042B is furnished with a shaping part that accommodates powder, a powder feed part that accommodates powder to be fed to the shaping part, and an inkjet head disclosed above the shaping part. The inkjet head ejects water-based ink onto the powder accommodated in the shaping part. More specifically, the inkjet head ejects water-based ink onto a portion of the powder accommodated in the shaping part that corresponds to a cross-sectional shape of the three-dimensional object. Of the powder accommodated in the shaping part, the portion to which the water-based ink is ejected is solidified, and a solidified layer corresponding to the cross-sectional shape is formed. Then, solidified layers are formed one by one, and subsequently-formed solidified layers are stacked on top of previously-formed solidified layers, so that a desired three-dimensional object is built.

In the powder bed-type three-dimensional printing apparatus as described in Japanese Patent No. 5400042B, it is necessary that, prior to solidifying a powder material, the powder material should be spread in the build region in which a three-dimensional object is to be formed and should be leveled off evenly, to form a powder layer. The powder layer may be formed by, for example, leveling off a powder material accumulated on a region external to the build region with a re-coater, such as a roller. In that case, however, the powder layer is susceptible to a defect unless the powder material is supplied in an amount that is considerably greater than is actually formed into the powder layer. More specifically, spreading of the powder material is often insufficient in edge portions of the build region (for example, left and right edge potions of the build region when the traveling direction of the re-coater is defined as forward). According to the knowledge of the present inventor, the insufficient spreading of powder occurs frequently unless the powder material is supplied in an amount that is about two to three times the amount of the powder material formed as the powder layer, per one time of supplying the powder material. However, in order to supply a larger amount of powder material, it is inevitable that the material feeding vat, for example, need to be larger in size, which leads to an undesirable size increase of the three-dimensional printing apparatus.

### SUMMARY OF THE INVENTION

Preferred embodiments of the present invention provide three-dimensional printing apparatuses that are each able to reliably form a powder layer in a build region with a relatively small amount of powder material.

A three-dimensional printing apparatus according to a preferred embodiment of this disclosure includes a build vat that includes a build region in which a three-dimensional object is to be formed, the build vat being capable of placing a powder material therein, a material feed device that feeds the powder material to the build vat, and a solidifying device that solidifies the powder material placed in the build region. The material feed device includes a feed table, a re-coater, a powder spread guide, and a transfer mechanism. The feed table is arrayed with the build vat along a first direction, and includes a feed region in which the powder material is to be placed. The re-coater extends in a second direction that is perpendicular or substantially perpendicular the first direction, and includes a leveler that levels off the powder material. The powder spread guide includes a contact surface that makes contact with the powder material. The transfer mechanism transfers the re-coater and the powder spread guide from a position above the feed table to a position above the build vat along the first direction. In transferring the re-coater, the transfer mechanism retains the re-coater so that a lowermost end of the leveler is kept at a first height that is lower than a height of the powder material placed on the feed region. In addition, the transfer mechanism retains the powder spread guide so that, in transferring the powder spread guide, a lower end of the contact surface is kept at a second height that is lower than the height of the powder material placed on the feed region, that the contact surface is positioned forward along the first direction relative to the leveler, and that at least a portion of the contact surface passes outside the build region with respect to the second direction. The contact surface is configured to transfer at least a portion of the powder material that makes contact with the contact surface to an inside of the build region in transferring the powder spread guide.

With such a three-dimensional printing apparatus, the contact surface of the powder spread guide pushes the powder material toward the inside of the build region. This allows the three-dimensional printing apparatus to supply the powder material in a larger amount to the edge portions of the build region than in the case of conventional apparatuses, and resolves insufficient spreading of the powder material in the edge portions of the build region. For this purpose, the powder spread guide is installed at a height lower than the powder material and disposed forward relative to the re-coater, which spreads the powder material into the build region. Thus, such a three-dimensional printing apparatus makes it possible to form a desirable powder layer in the build region even when the amount of the powder material supplied is relatively small.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view schematically illustrating a three-dimensional printing apparatus according to a preferred embodiment of the present invention.

FIG. 2 is a plan view schematically illustrating a three-dimensional printing apparatus according to a preferred embodiment of the present invention.

FIG. 3 is a perspective view schematically illustrating a layer formation mechanism.

FIG. 4 is a perspective view schematically illustrating a left-side powder spread guide.

FIG. 5 is a plan view schematically illustrating a region around the left-side powder spread guide.

FIG. 6 is a side view schematically illustrating the region around the left-side powder spread guide, viewed from the right to the left.

FIG. 7 is a plan view schematically illustrating a region around a build vat during formation of a powder layer.

FIG. 8A is a plan view schematically illustrating a powder spread guide of a first modified example of a preferred embodiment of the present invention.

FIG. 8B is a plan view schematically illustrating a powder spread guide of a second modified example of a preferred embodiment of the present invention.

FIG. 8C is a plan view schematically illustrating a powder spread guide of a third modified example of a preferred embodiment of the present invention.

FIG. 8D is a plan view schematically illustrating a powder spread guide of a fourth modified example of a preferred embodiment of the present invention.

### DETAILED DESCRIPTION OF THE PREFERRED EMBODIMENTS

Hereinbelow, preferred embodiments of three-dimensional printing apparatuses according to the present invention will be described with reference to the drawings. It should be noted, however, that the preferred embodiments described herein are, of course, not intended to limit the present invention. The features and components that exhibit the same effects are denoted by the same reference symbols, and repetitive description thereof may be omitted as appropriate.

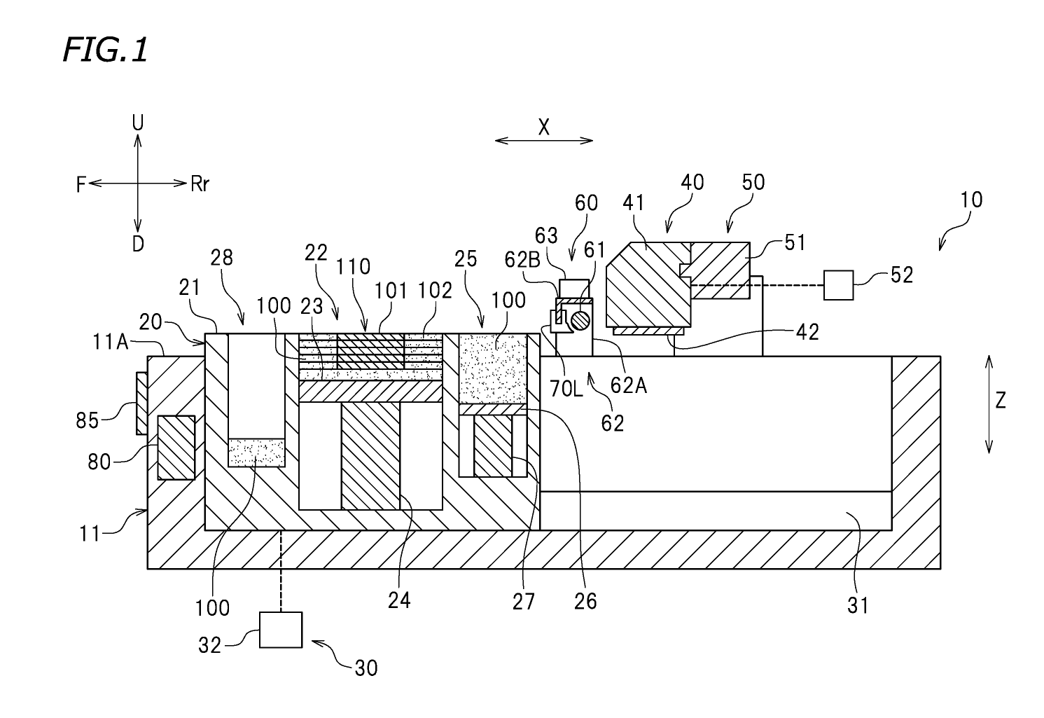

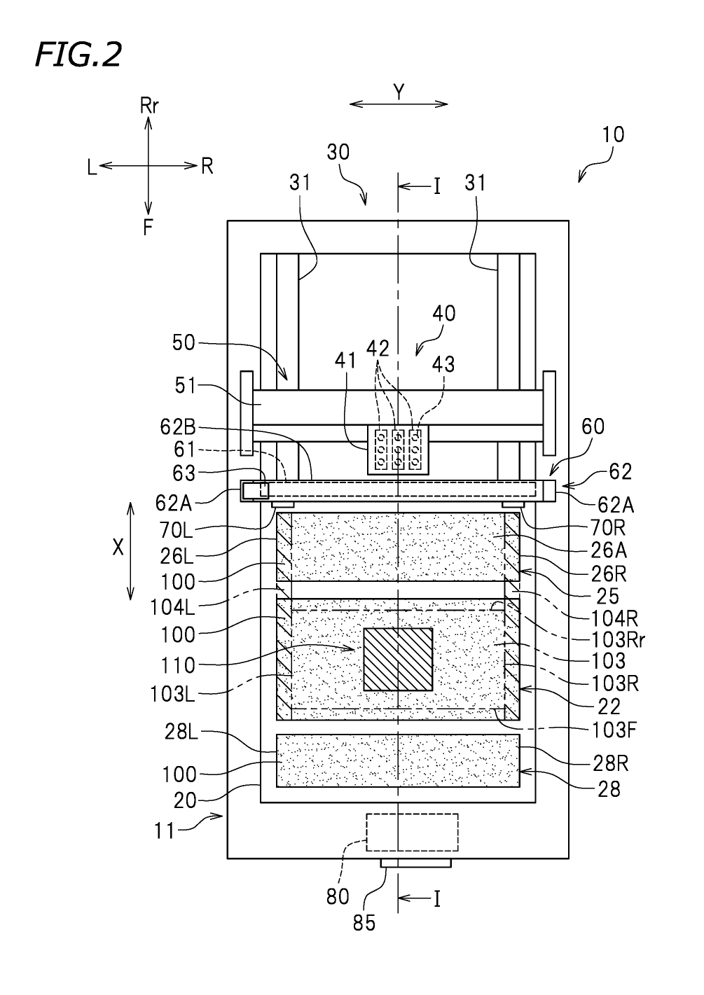

FIG. 1 is a cross-sectional view schematically illustrating a three-dimensional printing apparatus 10 according to a preferred embodiment of the present invention. FIG. 2 is a plan view of the three-dimensional printing apparatus 10 according to the present preferred embodiment. FIG. 1 is a cross-sectional view taken along line I-I in FIG. 2. In the drawings, reference character F represents front, and reference character Rr represents rear. In the present preferred embodiment, the terms left, right, up, and down, used to locate elements of the three-dimensional printing apparatus 10, are respectively left, right, up, and down as the three-dimensional printing apparatus 10 is viewed from the direction indicated by reference character F. Reference characters L, R, U, and D in the drawings represent left, right, up, and down, respectively. In the present preferred embodiment, reference characters X, Y, and Z represent a longitudinal direction (front-to-rear/rear-to-front), a lateral direction (left-to-right/right-to-left), and a vertical direction (up-down/down-up), respectively. The longitudinal direction X, the lateral direction Y, and the vertical direction Z are perpendicular or substantially perpendicular each other. The lateral direction Y extends along the main scanning direction of the three-dimensional printing apparatus 10. The longitudinal direction X extends along the sub-scanning direction of the three-dimensional printing apparatus 10. The vertical direction extends along the stacking direction in building a three-dimensional object. These directional terms are, however, merely provided for purposes in illustration and are not intended to limit the preferred embodiments of the three-dimensional printing apparatus 10 in any way.

As illustrated in FIG. 1, the three-dimensional printing apparatus 10 according to the present preferred embodiment is an apparatus that forms a three-dimensional object 110 by solidifying a powder material 100 using a solidifying liquid to form solidified layers 101, and stacking the solidified layers 101 one after another along the vertical direction Z. The three-dimensional printing apparatus 10 according to the present preferred embodiment spreads and fills the powder material 100 into a build vat 22 to form a powder layer 102, and thereafter ejects the solidifying liquid onto the powder material 100 to solidify the powder material 100 and to form a solidified layer 101, based on a cross-sectional image that represents a cross-sectional shape of the desired three-dimensional object 110. Thus, solidified layers 101 are formed in this manner one after another, and subsequently-formed solidified layers 101 are stacked on top of previously-formed solidified layers 101, to form the desired three-dimensional object 110.

The term “cross-sectional shape” herein means the shape of a cross section of the three-dimensional object 110 that is sliced at a predetermined thickness (for example, about 0.1 mm, note that the predetermined thickness is not limited to a uniform thickness).

The composition and shape of the powder material 100 are not limited to any particular composition or shape, and it is possible to use powder made of various materials, such as resin materials, metallic materials, and inorganic materials. Examples of the powder material 100 include ceramic materials, such as alumina, silica, titania, and zirconia; iron, aluminum, titanium, and alloys thereof (typically, stainless steels, titanium alloys, and aluminum alloys); hemihydrate gypsums (α-hemihydrate gypsum and β-hemihydrate gypsum); apatite; common salt; and plastics. These materials may be used either alone or in one or more combinations.

The “solidifying liquid” is not limited to any particular liquid as long as it is made of a material capable of firmly binding the powder material 100 together. For example, the solidifying liquid (including viscous material) is able to bind the particles that form the powder material. An example of the solidifying liquid may be a liquid containing water, wax, and a binder. When the powder material contains a water-soluble resin as an auxiliary material, the solidifying liquid may be a liquid capable of dissolving the water-soluble resin, such as water. The water-soluble resin is not limited to a particular type of water-soluble resin, and examples include starch, polyvinyl alcohol (PVA), polyvinyl pyrrolidone (PVP), water-soluble acrylic resin, water-soluble urethane resin, and water-soluble polyamide.

As illustrated in FIG. 1, the three-dimensional printing apparatus 10 includes a main body 11, a build vat unit 20, a sub-scanning-direction transfer mechanism 30, a head unit 40, a main-scanning-direction transfer mechanism 50, a layer formation mechanism 60, and a controller 80.

As illustrated in FIG. 2, the main body 11 is an outer casing of the three-dimensional printing apparatus 10, which has an oblong shape with longer sides along the sub-scanning direction X. The main body 11 preferably has a box-shaped structure that opens upwardly. The main body 11 accommodates the sub-scanning-direction transfer mechanism 30, the build vat unit 20, and the controller 80. As illustrated in FIG. 1, the main body 11 also defines and functions to support the layer formation mechanism 60 and the main-scanning-direction transfer mechanism 50.

As illustrated in FIG. 1, the build vat unit 20 is accommodated in the main body 11. The build vat unit 20 includes a build vat 22, a feed vat 25, and an excessive powder accommodating vat 28. An upper surface 21 of the build vat unit 20 is flat. The build vat 22, the feed vat 25, and the excessive powder accommodating vat 28 are provided independently from each other side by side so that they are recessed from the upper surface 21.

As illustrated in FIG. 1, the build vat 22 is provided in the build vat unit 20. The build vat 22 is a vat in which the three-dimensional object 110 is to be built. As illustrated in FIG. 2, the build vat 22 has a substantially rectangular shape when viewed in plan. However, the build vat 22 may not necessarily have a rectangular shape when viewed in plan. As illustrated in FIG. 1, a build table 23 is inserted into the build vat 22. The build table 23 has the same planar shape as that of the build vat 22. A build table elevating mechanism 24 is also provided inside the build vat 22. The build table elevating mechanism 24 causes the build table 23 to ascend and descend.

The build table elevating mechanism 24 is a mechanism that causes the build table 23 to move along the vertical direction Z. The specific configuration of the build table elevating mechanism 24 is not limited. In the present preferred embodiment, the build table elevating mechanism 24 may include a servomotor and a ball screw, for example, which are not shown in the drawings. The build table elevating mechanism 24 is connected to a bottom portion of the build table 23. The build table 23 is moved in upward and downward directions Z by the operation of the servomotor of the build table elevating mechanism 24. The build table elevating mechanism 24 is electrically connected to the controller 80, and is controlled by the controller 80.

The feed vat 25 is a vat in which the powder material 100 is stored before being supplied to the build vat 22. As illustrated in FIG. 2, the feed vat 25 preferably has a rectangular or substantially rectangular shape when viewed in plan, for example. It should be noted, however, that the planar shape of the feed vat 25 is not limited to a rectangular or substantially rectangular shape. As illustrated in FIG. 1, the feed vat 25 accommodates a feed table 26 therein. The feed table 26 preferably has the same planar shape as that of the feed vat 25. The powder material 100 on the feed table 26 is spread over the build table 23 of the build vat 22 by the formation mechanism 60, which is described later. The feed vat 25 is disposed behind the build vat 22. The feed vat 25 is disposed at a position aligned with the build vat 22 with respect to the main scanning direction Y. As illustrated in FIG. 2, when viewed in plan, the length of the feed vat 25 along the main scanning direction Y is equal to the length of the build vat 22 along the main scanning direction Y. In the present preferred embodiment, the entire region over the feed table 26 serves as a feed region 26A, on which the powder material 100 is placed and from which the powder material 100 is supplied to the build vat 22.

The feed table 26 is movable in upward and downward directions Z in the feed vat 25. A feed table elevating mechanism 27 is joined to a lower portion of the feed table 26. The feed table elevating mechanism 27 moves the feed table 26 in upward and downward directions Z. Although the configuration of the feed table elevating mechanism 27 is not particularly limited, the feed table elevating mechanism 27 of the present preferred embodiment, like the build table elevating mechanism 24, includes a servomotor, a ball screw, and so forth, which are not shown in the drawings. The feed table 26 is moved in an upward or downward direction Z by the operation of the servomotor of the feed table elevating mechanism 27. The feed table elevating mechanism 27 is electrically connected to the controller 80, and is controlled by the controller 80.

The excessive powder accommodating vat 28 collects an excess amount of the powder material 100 that cannot be accommodated in the build vat 22 when the powder material 100 is spread into the build vat 22 by the layer formation mechanism 60. The excessive powder accommodating vat 28 is disposed in front of the build vat 22. The excessive powder accommodating vat 28 is disposed at a position aligned with the build vat 22 with respect to the main scanning direction Y. As illustrated in FIG. 2, when viewed in plan, the length of the excessive powder accommodating vat 28 along the main scanning direction Y is equal to the length of the build vat 22 along the main scanning direction Y.

As illustrated in FIG. 1, the sub-scanning-direction transfer mechanism 30 transfers the build vat unit 20 along the sub-scanning direction X relative to the head unit 40 and the layer formation mechanism 60. In the present preferred embodiment, the sub-scanning-direction transfer mechanism 30 includes a pair of guide rails 31 and a feed motor 32.

As illustrated in FIG. 1, the guide rails 31 guide the movement of the build vat unit 20 along the sub-scanning direction X. The guide rails 31 are provided inside the main body 11. The guide rails 31 extend along the sub-scanning direction X. The build vat unit 20 is slidably engaged with the guide rails 31. It should be noted, however, that the number of the guide rails 31 is not limited to any particular number, and the position of each of the guide rails 31 is not limited to any position either. The feed motor 32 is connected to the build vat unit 20 via, for example, a ball screw. The feed motor 32 is electrically connected to the controller 80. The feed motor 32 rotates to drive the build vat unit 20 so that the build vat unit 20 is able to move along the guide rails 31 in a sub-scanning direction X.

As illustrated in FIG. 2, the head unit 40 includes a carriage 41 and a plurality of ejection heads 42 mounted on the carriage 41. The plurality of ejection heads 42 are disposed at the lower surface of the carriage 41. Each of the ejection heads 42 ejects a solidifying liquid for binding the powder material 100 onto the powder material 100 placed on the build table 23. As illustrated in FIG. 2, the plurality of ejection heads 42 are arrayed along the main scanning direction Y. Each of the ejection heads 42 includes a plurality of nozzles 43 to eject the solidifying liquid. The plurality of nozzles 43 are arrayed linearly along the sub-scanning direction X. The ejection heads 42 may include any type of mechanism to eject the solidifying liquid. For example, an inkjet system may be suitably used. The ejection heads 42 are electrically connected to the controller 80. Ejection of the solidifying liquid from the nozzles 43 of the ejection heads 42 is controlled by the controller 80.

The main-scanning-direction transfer mechanism 50 transfers the carriage 41 along the main scanning direction Y. The main-scanning-direction transfer mechanism 50 is provided over the main body 11. As illustrated in FIG. 2, the main-scanning-direction transfer mechanism 50 includes a guide rail 51. The guide rail 51 extends along the main scanning direction Y. A carriage 41 is slidably engaged with the guide rail 51. A carriage motor 52 is connected to the carriage 41 via an endless belt, a pulley, and so forth. The carriage motor 52 operates so as to cause the carriage 41 to move in the main scanning directions Y along the guide rail 51. The carriage motor 52 is electrically connected to a controller 80. The carriage motor 52 is controlled by the controller 80. As the carriage 41 moves in a main scanning direction Y, the plurality of ejection heads 42 accordingly move in the main scanning direction Y.

The plurality of ejection heads 42 mounted on the carriage 41 are transferred to a desired position above the build vat 22 by the operations of the sub-scanning-direction transfer mechanism 30 and the main-scanning-direction transfer mechanism 50. The sub-scanning-direction transfer mechanism 30, the main-scanning-direction transfer mechanism 50, and the head unit 40 define a solidifying device that solidifies the powder material 100 to build a three-dimensional object 110. The three-dimensional object 110 is built within a predetermined build region 103 on the build vat 22. The three-dimensional object 110 may not be built at all the locations in the entire region of the build table 23, and the build region 103 is the maximum region in which the three-dimensional object 110 is able to be built when viewed in plan. As illustrated in FIG. 2, the build region 103 is a rectangular or substantially rectangular region on the build vat 22, and the build region 103 has virtual boundary lines respectively at its front, rear, left, and right sides. The build region 103 is defined by a front-side boundary line 103F, a rear-side boundary line 103Rr, a left-side boundary line 103L, and a right-side boundary line 103R. The left-side boundary line 103L is positioned rightward relative to the left end 26L of the feed table 26 and the left end 28L of the excessive powder accommodating vat 28. The right-side boundary line 103R is positioned leftward relative to the right end 26R of the feed table 26 and the right end 28R of the excessive powder accommodating vat 28. In other words, the length of the feed vat 25 and that of the excessive powder accommodating vat 28 along the main scanning direction Y is longer than the length of the build region 103 along the main scanning direction Y.

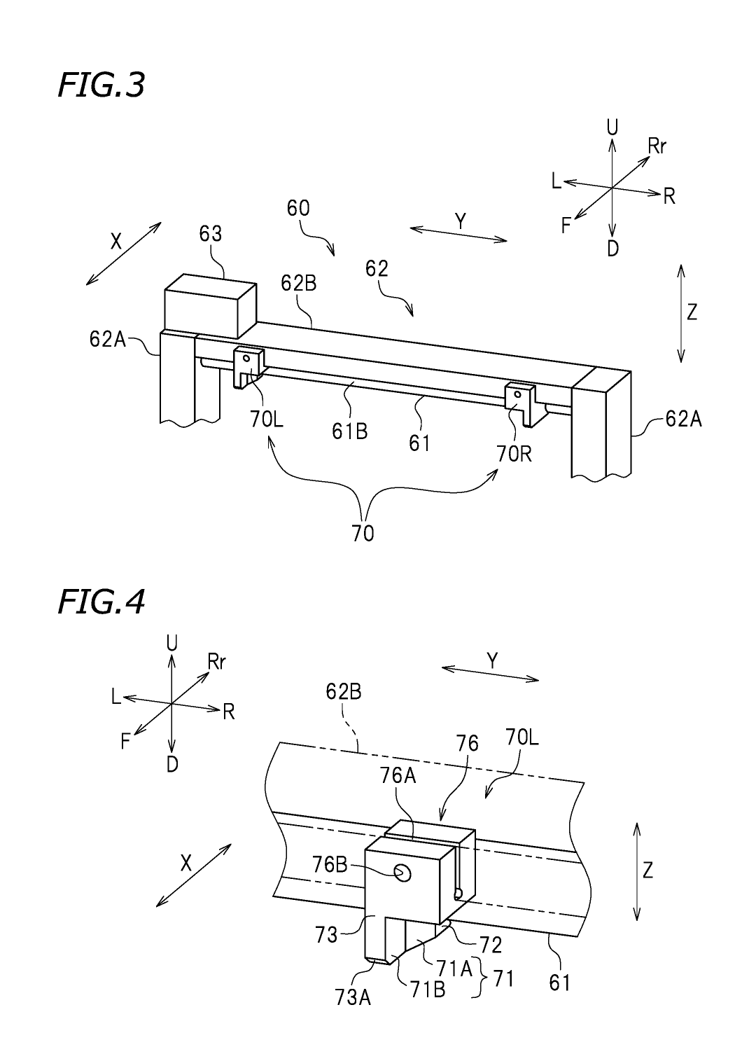

The layer formation mechanism 60 causes the powder material 100 stored in the feed vat 25 to be spread into the build vat 22 to form a powder layer 102. The layer formation mechanism 60, the sub-scanning-direction transfer mechanism 30, and the components that form the feed vat 25 (the feed vat 25, the feed table 26, and the feed table elevating mechanism 27) define a material feed device that feeds the powder material 100 to the build vat 22. As the build vat unit 20 is transferred by the sub-scanning-direction transfer mechanism 30, the layer formation mechanism 60 moves relative to the build vat unit 20. More specifically, the layer formation mechanism 60 passes over the build vat 22, the feed vat 25, and the excessive powder accommodating vat 28. FIG. 3 is a perspective view schematically illustrating the layer formation mechanism 60 according to the present preferred embodiment. As illustrated in FIG. 3, the layer formation mechanism 60 includes a roller 61, a retaining member 62, a roller motor 63, a left-side powder spread guide 70L, and a right-side powder spread guide 70R. Note that in the following description, the left-side powder spread guide 70L and the right-side powder spread guide 70R may be collectively referred to as a powder spread guide 70.

The roller 61 levels off the surface of the powder material 100 to form the powder layer 102. Among the members of the layer formation mechanism 60, the roller 61 makes contact with the powder material 100. The roller 61 is an example of the “re-coater” that levels off the surface of the powder material 100 to form the powder layer 102. The roller 61 is rotatably retained by the retaining member 62 provided on a top surface 11A of the main body 11. The retaining member 62 includes a pair of frames 62A and a bridge 62B. As illustrated in FIG. 2, a right-side frame 62A, one of the pair of frames 62A, is provided rightward relative to the build vat unit 20. A left-side frame 62A is provided leftward relative to the build vat unit 20. The pair of frames 62A are disposed forward relative to the head unit 40. The bridge 62B spans horizontally between the pair of frames 62A. The bridge 62B extends along the main scanning direction Y. The bridge 62B rotatably retains the roller 61. The bridge 62B is provided with the roller motor 63. The roller motor 63 causes the roller 61 to rotate. The roller motor 63 and the roller 61 are connected to each other by a connecting device (not shown) that is provided with gears, for example. The roller motor 63 is electrically connected to the controller 80 so as to cause the roller 61 to rotate based on the control by the controller 80.

The roller 61 preferably has an elongated cylindrical shape. The roller 61 is retained by the retaining member 62 so that its cylindrical axis extends along the main scanning direction Y. The roller 61 extends along the main scanning direction Y and its length is longer than the dimension of the build region 103 along the main scanning direction Y. In addition, although the length of the roller 61 is longer than the dimension of the build vat 22 along the main scanning direction Y, it is sufficient that the roller 61 be longer than the dimension of the build region 103 along the main scanning direction Y, so the roller 61 need not necessarily be longer than the dimension of the build vat 22 along the main scanning direction Y. The roller 61 is supported above the main body 11. The roller 61 is retained so that its lowermost end 61A is positioned at a predetermined height T1 from the upper surface 21 of the build vat unit 20 (see FIG. 6). Although the roller 61 is rotatable, the height T1 of the lowermost end 61A is constant or substantially constant because the roller 61 has a cylindrical or substantially cylindrical shape. The height T1 of the lowermost end 61A of the roller 61 (hereinafter simply referred to as the height T1 of the roller 61) is lower than the height of the powder material 100 at which the powder material 100 is piled up on the feed region 26A when the powder material 100 is supplied. For this reason, when the powder material 100 is supplied, the roller 61 comes into contact with the powder material 100 at its front lower portion 61B. The front lower portion 61B of the roller 61 (see also FIG. 6) is an example of “leveler” that makes contact with the powder material 100 and levels off the powder material 100.

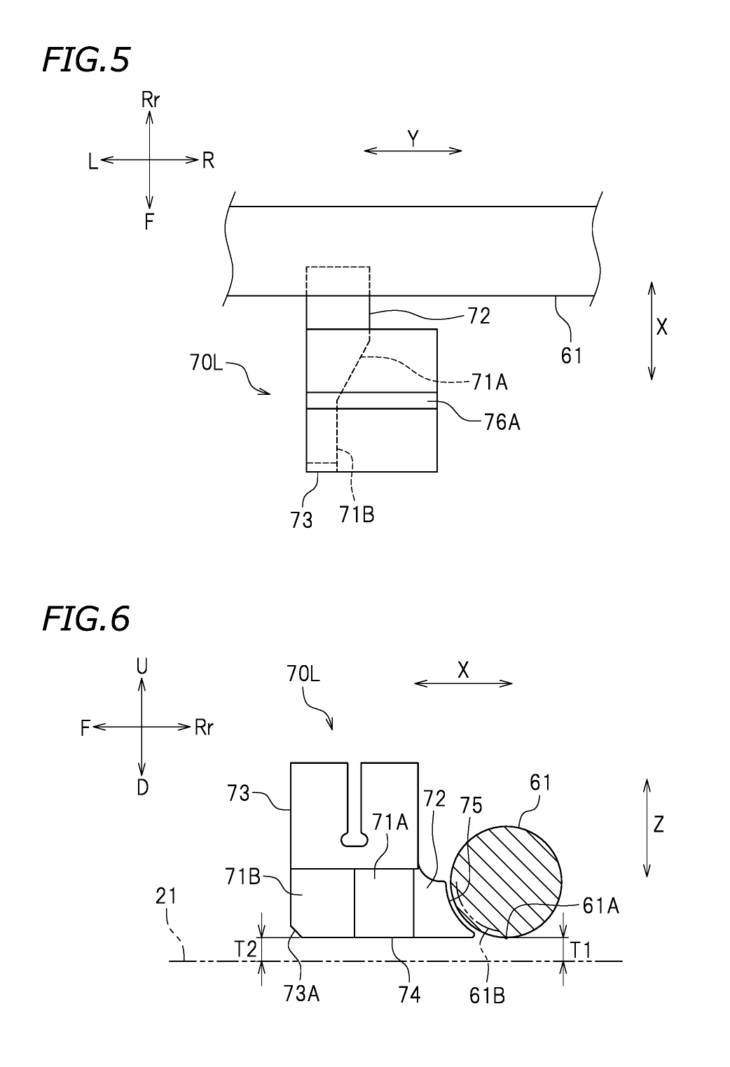

The left-side powder spread guide 70L and the right-side powder spread guide 70R are secured to the bridge 62B. FIG. 4 is a perspective view schematically illustrating the left-side powder spread guide 70L. FIG. 5 is a plan view schematically illustrating a region around the left-side powder spread guide 70L. FIG. 6 is a side view schematically illustrating the region around the left-side powder spread guide 70L, viewed from right to left. Although the right-side powder spread guide 70R is not illustrated in details in the drawings, the right-side powder spread guide 70R has a laterally symmetrical shape with the left-side powder spread guide 70L.

The left-side powder spread guide 70L is secured to the bridge 62B by a securing part 76. As illustrated in FIG. 4, the securing part 76 herein includes a slit 76A and a bolt hole 76B. A portion of the bridge 62B is inserted in the slit 76A, and the securing part 76 and the bridge 62B are secured by a bolt, not shown, through the bolt hole 76B. It should be noted, however, that the above-described structure of the securing part 76 is merely an example, and the securing part 76 is not limited thereto. As illustrated in FIGS. 4 to 6, the left-side powder spread guide 70L includes a first guide surface 71A inclined with respect to the sub-scanning direction X, and a second guide surface 71B protruding forward from the first guide surface 71A. The second guide surface 71B is positioned leftward (i.e., outward) relative to the first guide surface 71A. The first guide surface 71A and the second guide surface 71B together define a contact surface 71 that makes contact with the powder material 100. An inner side surface 72 is provided behind the first guide surface 71A. A front surface 73 is provided in front of the second guide surface 71B. All of the first guide surface 71A, the second guide surface 71B, the inner side surface 72, and the front surface 73 are vertical surfaces.

As illustrated in FIG. 5, when viewed in plan, the first guide surface 71A is inclined gradually more toward the right as it extends from front to rear. In other words, the first guide surface 71A extends from left front toward right rear. The second guide surface 71B is a vertical surface that is connected to the front end of the first guide surface 71A so as to extend forward from the front end of the first guide surface 71A. The second guide surface 71B extends parallel or substantially parallel to the sub-scanning direction X. Therefore, the second guide surface 71B faces rightward. The inner side surface 72 is a vertical surface that is connected to the rear end of the first guide surface 71A and is parallel or substantially parallel to the sub-scanning direction X. The inner side surface 72 faces rightward.

The front surface 73 is the frontmost surface of the left-side powder spread guide 70L, and it is a vertical surface that is perpendicular or substantially perpendicular to the sub-scanning direction X. The front surface 73 includes a chamfered portion 73A at its lowermost end. The chamfered portion 73A is an inclined surface that is chamfered toward the rear. The chamfered portion 73A extends from upper front toward lower rear. The chamfered portion 73A is inclined, for example, about 45 degrees with respect to the vertical plane.

As illustrated in FIG. 6, a bottom surface 74 of the left-side powder spread guide 70L is parallel or substantially parallel to the upper surface 21 of the build vat unit 20. The bottom surface 74 is a horizontal surface. As illustrated in FIG. 6, the bottom surface 74 is located a predetermined height T2 above the upper surface 21 of the build vat unit 20. The height T2 of the bottom surface 74 of the left-side powder spread guide 70L with respect to the upper surface 21 of the build vat unit 20 (hereinafter simply referred to as the height T2 of the left-side powder spread guide 70L) is equal or substantially equal to the height T1 of the roller 61 in the present preferred embodiment.

As illustrated in FIG. 6, a rear surface 75 is connected to the rear end of the inner side surface 72. The rear surface 75 is a curved surface extending curvedly upward. The rear surface 75 is located rearmost in the left-side powder spread guide 70L and close to the front lower portion 61B (i.e., the leveler) of the roller 61. As illustrated in FIG. 6, the rear surface 75 is curved so as to extend along the outer circumference of the front lower portion 61B of the roller 61. Thus, the rear surface 75 is disposed so that its lowermost end protrudes to be at the rearmost position while its uppermost end is located to at the frontmost position.

As illustrated in FIG. 2, the left-side powder spread guide 70L is attached to the retaining member 62 so as to be located forward relative to the roller 61. The main portion of the left-side powder spread guide 70L is positioned in a region between the left-side boundary line 103L of the build region 103 and the left end 26L of the feed table 26 (the region is hereinafter referred to as a left-side peripheral edge region 104L, when appropriate) with respect to the main scanning direction Y. More specifically, the left-side powder spread guide 70L is installed so that the inner side surface 72 is positioned on the left-side boundary line 103L of the build region 103, and the second guide surface 71B is positioned on the left end 26L of the feed table 26. In other words, the right end of the first guide surface 71A of the left-side powder spread guide 70L is positioned on the left-side boundary line 103L of the build region 103, and the left end thereof is positioned on the left end 26L of the feed table 26. Accordingly, when the build vat unit 20 is transferred in a sub-scanning direction X, the first guide surface 71A passes over the left-side peripheral edge region 104L. It should be noted, however, that the position of the rightmost end of the first guide surface 71A may not necessarily be directly above the left-side boundary line 103L of the build region 103, but it may be, for example, slightly off to the left (outside the build region 103). The position of the leftmost end of the first guide surface 71A may not necessarily be directly above the left end 26L of the feed table 26, but may be slightly off to the right (inside the feed region 26A).

Like the left-side powder spread guide 70L, the right-side powder spread guide 70R is installed so that the inner side surface is positioned on the right-side boundary line 103R of the build region 103, and the second guide surface is positioned on the right end 26R of the feed table 26. Accordingly, when the build vat unit 20 is transferred in a sub-scanning direction X, the first guide surface of the right-side powder spread guide 70R passes over the right-side peripheral edge region 104R (i.e., the region between the right-side boundary line 103R of the build region 103 and the right end 26R of the feed table 26).

As illustrated in FIG. 1, an operation panel 85 is provided on a front surface of the main body 11. The operation panel 85 is provided with a display that displays the operating status, input keys to be operated by the user, and so forth. The operation panel 85 is connected to the controller 80, which controls various operations of the three-dimensional printing apparatus 10. The controller 80 is connected to the feed motor 32, the carriage motor 52, the ejection heads 42, the build table elevating mechanism 24, the feed table elevating mechanism 27, and the roller motor 63, so as to control the operations of these elements.

The configuration of the controller 80 is not limited to a particular configuration. The controller 80 may be a microcomputer, for example. The hardware configuration of the microcomputer is not limited in any way. For example, the microcomputer may include an interface (I/F) that receives object building data or the like from external apparatuses such as a host computer, a central processing unit (CPU) that executes control program instructions, a read only memory (ROM) that stores programs executed by the CPU, a random access memory (RAM) used as a working area to deploy the programs, and a storage device, such as a memory, that stores the foregoing programs and various data. The controller 80 need not be provided inside the three-dimensional printing apparatus 10. For example, the controller 80 may be a computer that is provided external to the three-dimensional printing apparatus 10 and communicatively connected to the three-dimensional printing apparatus 10 via a wired or wireless communication.

The three-dimensional printing apparatus 10 according to the present preferred embodiment builds a three-dimensional object 110 by repeating a process including lowering of the build table 23, formation of a powder layer 102, and formation of a solidified layer 101. After completing formation of one solidified layer 101, the controller 80 according to the present preferred embodiment controls the build table elevating mechanism 24 to cause the build table 23 to descend by the thickness of the next one of solidified layers 101. At the same time, the controller 80 controls the feed table elevating mechanism 27 to elevate the feed table 26. This elevation of the feed table 26 causes the powder material 100 to be stacked up on the feed vat 25. The stacked-up powder material 100 is pushed toward the build vat 22 by the roller 61 traveling thereon, and a portion thereof is spread over the build table 23. The remaining portion of the powder material 100 that has not been spread is collected into the excessive powder accommodating vat 28. Thus, another powder layer 102 is formed over the solidified layer 101. After formation of the powder layer 102, the controller 80 controls the feed motor 32, the ejection heads 42, and the carriage motor 52 to cause a solidifying liquid to be ejected onto a desired location on the build region 103, to form another solidified layer 101.

As described above, in the process of forming the powder layer 102, the powder material 100 is supplied from the feed vat 25 to the build vat 22 each time a layer is formed. In conventional three-dimensional printing apparatus, however, the powder layer 102 is susceptible to a defect unless the powder material 100 is supplied in an amount that is considerably greater than is actually formed into the powder layer 102. More specifically, spreading of the powder material tends to be insufficient in the areas of the build region 103 that are adjacent to the left-side boundary line 103L and the right-side boundary line 103R. Especially, the insufficient spreading of powder material occurs particularly in an area adjacent to the front-side boundary line 103F. This occurs because the powder material 100 gathers toward the center of the build region 103 or spills sideward out of the build region 103 during the travel of the roller 61. According to the knowledge of the present inventor, the insufficient spreading of powder occurs frequently unless the powder material 100 is supplied in an amount that is about two to three times the amount of the powder material 100 that forms the powder layer 102 per one supply of the powder material 100. Because the build region 103 is a region in which the three-dimensional object 110 is formed, it is beneficial to form the powder layer 102 in good condition. However, in order to supply a larger amount of the powder material 100, it is inevitable that the feed vat 25 and the excessive powder accommodating vat 28 need to be larger in size, which leads to an undesirable size increase of the three-dimensional printing apparatus 100.

In view of this, the three-dimensional printing apparatus 10 according to the present preferred embodiment is provided with the powder spread guide 70 forward of the roller 61 in a travel direction so that a powder layer 102 is able to be formed with a relatively small amount of powder material 100. The contact surface 71 of the powder spread guide 70 makes contact with the powder material 100 earlier than the leveler (i.e., the front lower portion 61B) of the roller 61, and transfers the powder material 100 that has made contact with the contact surface 71 toward the inside of the build region 103. The contact surface 71 is configured so that the height of its lowermost end is at a height T1 that is lower than the height of the powder material 100 placed on the feed region 26A, and at least a portion thereof passes outside the build region 103. The contact surface 71 has a shape that collects the powder material 100 that comes into contact therewith toward the inside of the build region 103. As a result, the three-dimensional printing apparatus 10 according to the present preferred embodiment is able to supply the powder material 100 in a greater amount than conventional apparatuses to the areas adjacent to the left and right boundary lines 103L and 103R of the build region 103. The roller 61 flattens the powder material 100 transferred to the inside of the build region 103 by the powder spread guide 70 to form a desirable powder layer 102 that is free from defects. Thus, the three-dimensional printing apparatus 10 according to the present preferred embodiment makes it possible to form a desirable powder layer 102 even when the amount of the powder material supplied is relatively small.

Hereinbelow, a process of forming the powder layer 102 will be described. As descend previously, after completing formation of the first one of solidified layers 101, the controller 80 controls the build table elevating mechanism 24 to cause the build table 23 to descend by the thickness of the next one of solidified layers 101. The distance by which the build table 23 is lowered is, for example, about 0.1 mm. At the same time, the controller 80 controls the feed table elevating mechanism 27 to cause the feed table 26 to ascend. In the present preferred embodiment, the amount of the powder material 100 to be supplied then is, for example, about 1.3 to about 1.5 times the amount of the powder material 100 that actually forms the powder layer 102. According to the knowledge of the present inventor, the present preferred embodiment makes it possible to form a desirable powder layer 102 when the powder material 100 is supplied in an amount about 1.3 to about 1.5 times the amount of the powder material 100 that actually forms the powder layer 102, for example.

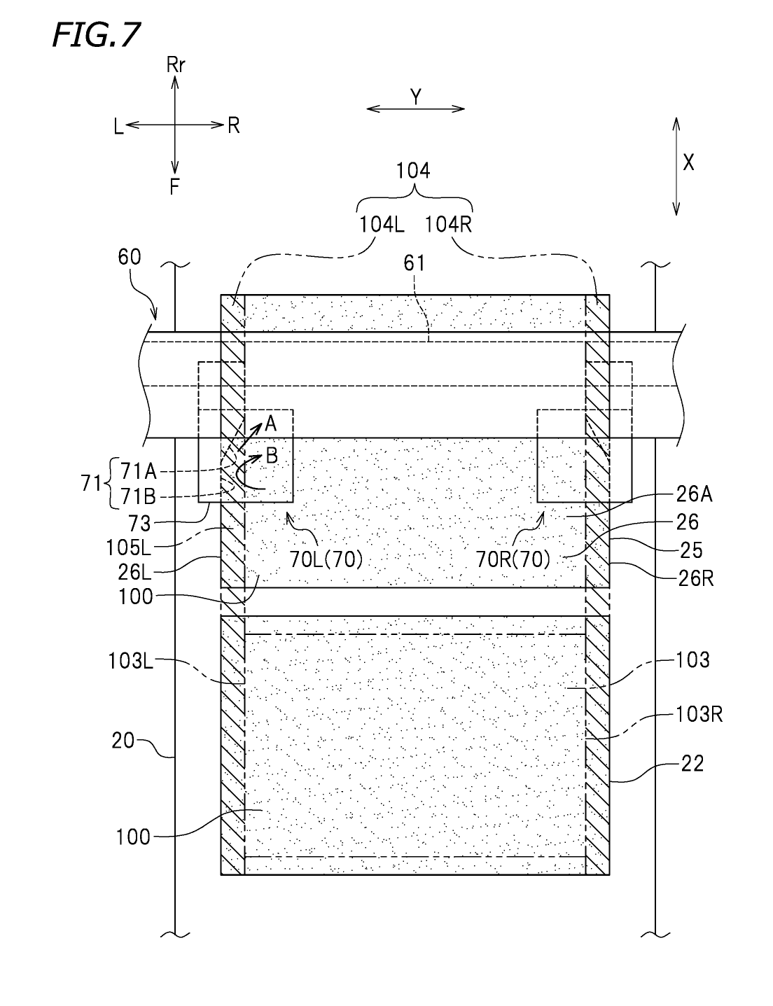

The powder material 100 stacked up by the elevation of the feed table 26 is formed into a powder layer 102 in the next step. FIG. 7 is a plan view schematically illustrating a region around the build vat 22 during formation of the powder layer 102. In FIG. 7, the controller 80 is controlling the feed motor 32 to cause the build vat unit 20 to move rearward. Accordingly, the layer formation mechanism 60 is traveling forward relative to the build vat unit 20. As illustrated in FIG. 7, while the layer formation mechanism 60 is traveling over the feed region 26A, the first guide surface 71A of the left-side powder spread guide 70L is passing over the left-side peripheral edge region 104L. The powder material 100 is placed on a region 105L of the left-side peripheral edge region 104L, which is also on the feed region 26A. The first guide surface 71A makes contact with the powder material 100 in the region 105L. Thus, the three-dimensional printing apparatus 10 according to the present preferred embodiment causes the powder spread guide 70 to travel over the peripheral edge region 104 and to transfer the powder material 100 placed on the peripheral edge region 104 toward the inside of the build region 103, and thereby supplies a larger amount of the powder material 100 to the areas adjacent to the left and right edge portions of the build region 103.

The first guide surface 71A of the left-side powder spread guide 70L is a vertical surface extending from left front toward right rear. Accordingly, the powder material 100 that has come into contact with first guide surface 71A is guided diagonally rightward and rearward. The rear end of the first guide surface 71A is aligned with the left-side boundary line 103L of the build region 103 with respect to the main scanning direction Y, so a large portion of the powder material 100 on the region over which the first guide surface 71A has passed is transferred to the inside of the build region 103 (as indicated by the arrow A in FIG. 7). At this time, the rightmost end of the first guide surface 71A passes on and along the left-side boundary line 103L of the build region 103, so it guides the portion of the powder material 100 that exists even in an innermost portion of the left-side peripheral edge region 104L directly to the inside of the build region 103. It should be noted, however, that the right end of the first guide surface 71A may pass slightly outside the left-side boundary line 103L of the build region 103. The roller 61 is disposed behind the left-side powder spread guide 70L, so the portion of the powder material 100 that has been guided by the first guide surface 71A is added in forming the powder layer 102.

At this time, the roller 61 is driven and rotated by the roller motor 63, and the powder material 100 is pressed by the rotation of the roller 61, so that a more solid powder layer 102 is formed.

In the present preferred embodiment, the left-side powder spread guide 70L also includes the second guide surface 71B. The second guide surface 71B is a vertical surface extending along the sub-scanning direction X, and it prevents the powder material 100 from spilling out leftward from the left end 26L of the feed table 26 (as indicated by the arrow B in FIG. 7). In the present preferred embodiment, the second guide surface 71B is arranged so as to pass on and along the left end 26L of the feed table 26. The second guide surface 71B is configured to pass on and along the left end 26L of the feed table 26 to push the powder material 100 back to the inside of the feed region 26A over the entire area of the feed region 26A and prevent the powder material 100 from spilling outside the feed region 26A. It should be noted, however, that the second guide surface 71B may pass slightly inside the left end 26L of the feed table 26. As illustrated in FIG. 6, the front surface 73 is provided with the chamfered portion 73A so that it can quickly transfer the powder material 100 rearward even when the powder material 100 makes contact with the front surface 73.

Moreover, in the present preferred embodiment, the height T2 of the left-side powder spread guide 70L and the height T1 of the roller 61 are set at the same height. If the height T2 of the left-side powder spread guide 70L is lower than the height T1 of the roller 61, the left-side powder spread guide 70L may scrape the powder material 100 that is to be leveled off by the roller 61, which is undesirable. If the height T2 of the left-side powder spread guide 70L is higher than the height T1 of the roller 61, the amount of the powder material 100 guided by the contact surface 71 decreases, reducing the effect obtained by the left-side powder spread guide 70L. For this reason, it is preferable that the height T2 of the left-side powder spread guide 70L be at the same height as the height T1 of the roller 61. However, it is also possible that the height T2 of the left-side powder spread guide 70L may be slightly higher than the height T1 of the roller 61.

As illustrated in FIG. 6, the rear surface 75 of the left-side powder spread guide 70L extends rearward along the outer circumferential surface of the roller 61, so as to narrow the gap between the outer circumferential surface of the roller 61 and the left-side powder spread guide 70L. This reduces the amount of the powder material 100 that escapes out of the build region 103 from the gap between the outer circumferential surface of the roller and the left-side powder spread guide 70L, increasing the advantageous effect of the left-side powder spread guide 70L.

Although the foregoing has described the left-side powder spread guide 70L, the same discussion applies to the right-side powder spread guide 70R. The right-side powder spread guide 70R transfers a portion of the powder material 100 placed on the right-side peripheral edge region 104R to the inside of the build region 103 so as to aid the formation of a desirable powder layer 102 in an area adjacent to the right-side boundary line 103R.

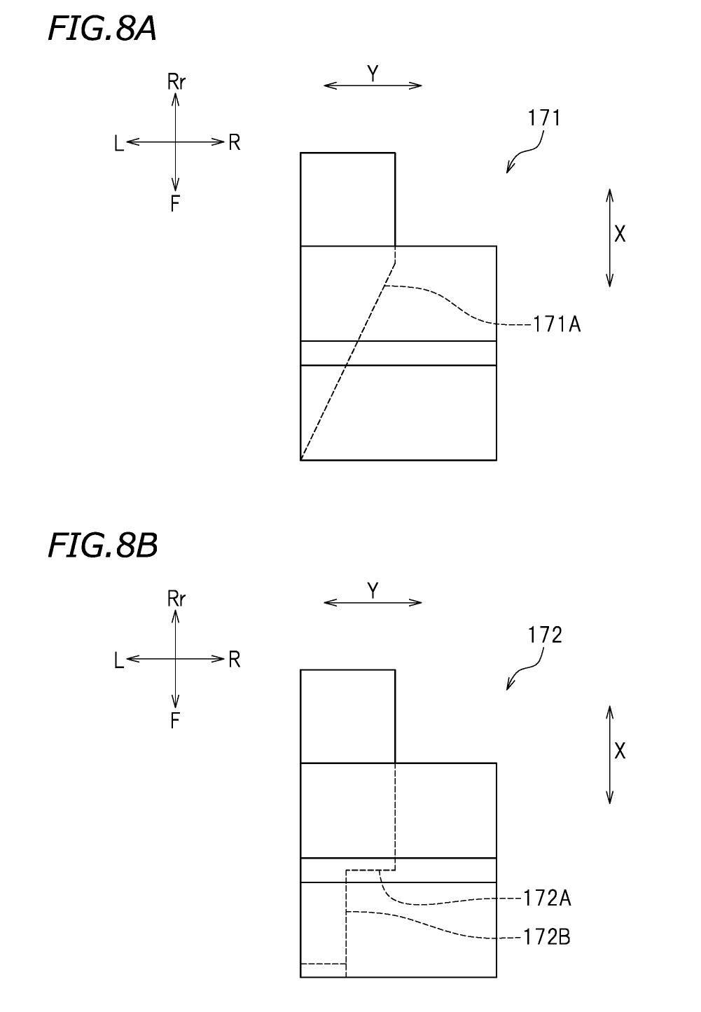

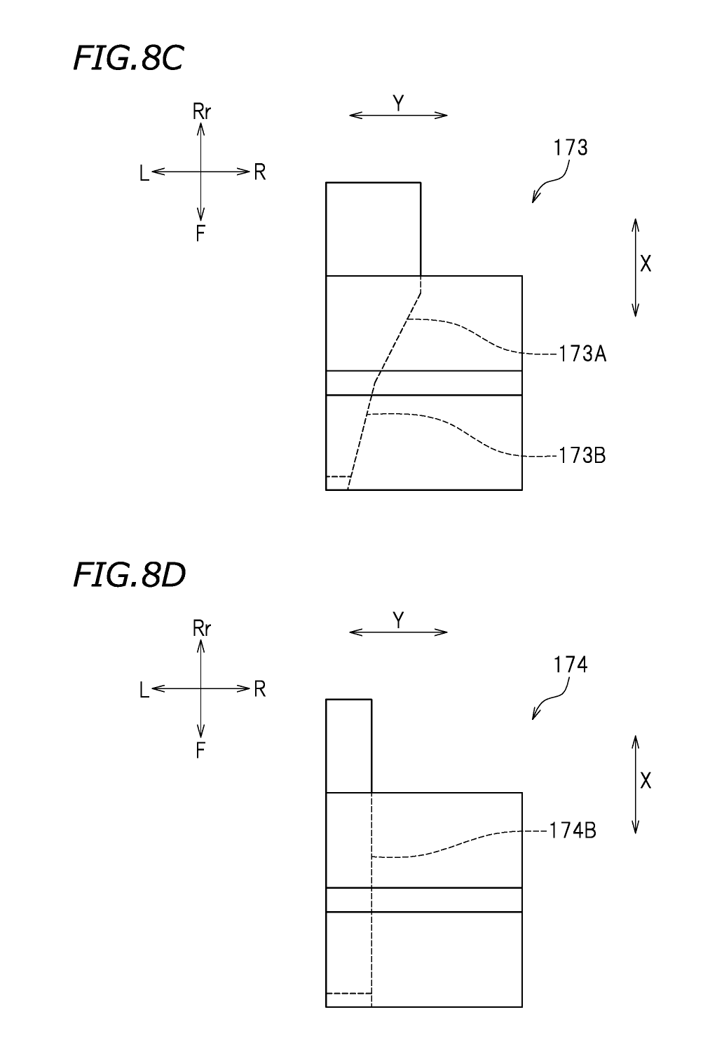

The shape of the powder spread guide may be embodied in other modified examples, in addition to the shape described above. FIGS. 8A to 8D are plan views schematically illustrating powder spread guides 171 to 174 of first to fourth modified examples of preferred embodiments of the present invention, respectively.

As illustrated in FIG. 8A, a powder spread guide 171 of the first modified example is a modified example of a preferred embodiment of the present invention in which the second guide surface is eliminated from its contact surface and only a first guide surface 171A is provided for the contact surface. As in the powder spread guide 171 of the first modified example, it is also possible to guide the powder material 100 to the inside of the build region 103 even with the first guide surface 171A alone, to obtain the advantageous effects. In other words, the powder spread guide may not necessarily be provided with the second guide surface.

As illustrated in FIG. 8B, a powder spread guide 172 of the second modified example is a modified example of a preferred embodiment of the present invention in which a first guide surface 172A is parallel or substantially parallel to the main scanning direction Y. Even when the first guide surface 172A is in such a configuration, it is also possible to guide the powder material 100 to the inside of the build region 103 by a combination with the second guide surface 172B, to obtain the advantageous effects. In other words, the first guide surface may not necessarily be inclined with respect to the main scanning direction Y as viewed in plan.

As illustrated in FIG. 8C, a powder spread guide 173 of the third modified example is a modified example of a preferred embodiment of the present invention in which a second guide surface 173B is inclined with respect to the sub-scanning direction X. In this modified example, when viewed in plan, the second guide surface 173B is inclined with respect to the sub-scanning direction X, and the second guide surface 173B is connected with a first guide surface 173A at a more obtuse angle than in the preferred embodiment described first. Such a preferred embodiment is also possible to guide the powder material 100 to the inside of the build region 103, to obtain the advantageous effects. In other words, the second guide surface may not necessarily be parallel to the sub-scanning direction X. It should be noted that the first guide surface 173A and the second guide surface 173B may have the same inclination angle with respect to the sub-scanning direction X as viewed in plan so that they define a single surface.

As illustrated in FIG. 8D, a powder spread guide 174 of the fourth modified example does not include the first guide surface but includes a second guide surface 174B. The bottom portion of the powder spread guide 174 of this modified example preferably has a simple rectangular shape. In this modified example as well, the second guide surface 174B passes on and along the left end 26L of the feed table 26. Therefore, in this modified example, the contact surface of the powder spread guide 174 does not pass over the peripheral edge region 104, and it does not actively transfer the powder material 100 placed on the peripheral edge region 104. However, such a preferred embodiment is also able to prevent the powder material 100 from spilling out of the build region 103, and ensures a larger amount of powder material 100 within the build region 103 than conventional apparatuses. In other words, it is possible to obtain the advantageous effect of forming the powder layer 102 with a smaller amount of powder material 100.

In the foregoing preferred embodiments, the contact surface and the other surfaces of the powder spread guide are vertical surfaces, but this is not essential. It is sufficient that the contact surface should be able to move at least a portion of the contacted powder material 100, and it may not necessarily be a vertical surface. For example, the contact surface may be an inclined surface that is inclined at an acute angle or an obtuse angle with respect to the horizontal plane. Additionally, the shape of the powder spread guide is not limited to the above-described shapes, but may include any shape that is able to exhibit the advantageous effects. However, that vertical surfaces offer the advantages of readiness and low cost in manufacturing. In addition, although the foregoing preferred embodiments have described that the contact surface includes one or a plurality of planar surfaces, it is also possible that the contact surface may include a curved surface.

Hereinabove, some of the preferred embodiments of the present invention have been described. It should be noted, however, that the foregoing preferred embodiments are merely exemplary and the present invention may be embodied in various other forms.

For example, in the foregoing preferred embodiments, the length of the build vat 22 along the main scanning direction Y and the length of the feed vat 25 along the main scanning direction Y are the same, and the length of the build region 103 along the main scanning direction Y is shorter than the length of the build vat 22 along the main scanning direction Y. However, the relationship in size between the length of the build vat 22 along the main scanning direction Y, the length of the feed vat 25 along the main scanning direction Y, the length of the build region 103 along the main scanning direction Y, and the length of the feed region 26A (the region in which the powder material 100 is actually supplied) in the feed vat 25 along the main scanning direction Y may be freely determined as long as they are within an acceptable range. For example, the length of the feed vat 25 along the main scanning direction Y may be longer than the length of the build vat 22 along the main scanning direction Y. It is also possible that the length of the feed region 26A along the main scanning direction Y may be shorter than the length of the feed vat 25 along the main scanning direction Y.

In the foregoing preferred embodiments, the inner side surface 72 of the powder spread guide 70 passes on and along a boundary line of the build region 103 and the second guide surface 71B passes on and along a boundary line of the feed region 26A, but this is not essential. The inner side surface 72 of the powder spread guide 70 may pass either an inside or an outside of the build region 103. The second guide surface 71B may pass either an inside or an outside of the feed region 26A.

Moreover, although the present preferred embodiments have described that almost the entirety of the powder spread guide 70 is retained forward relative to the roller 61, the positional relationship between the powder spread guide 70 and the roller 61 is not limited thereto. In the positional relationship between the powder spread guide 70 and the roller 61, at least the contact surface 71 of the powder spread guide 70 should be disposed more forward relative to the leveler 61B of the roller 61, and the positional relationship between other parts may be determined freely as desired.

Furthermore, although the foregoing preferred embodiments have described that the roller 61 and the powder spread guide 70 are secured to the same retaining member 62 and are transferred simultaneously by the same sub-scanning-direction transfer mechanism 30, but this is merely illustrative. It is also possible that the roller 61 and the powder spread guide 70 may be retained independently by separate retaining members, and that the roller 61 and the powder spread guide 70 may be transferred independently by separate drive mechanisms. That said, the configuration in which the roller 61 and the powder spread guide 70 are retained by the same single retaining member and the retaining member is transferred by the same single drive mechanism is simple and reliable, so it is advantageous in terms of the number of parts, the size of the apparatus, and costs.

In the foregoing preferred embodiments, the material feed device includes the roller 61, the sub-scanning-direction transfer mechanism 30, and the elements defining the feed vat 25 (i.e., the feed vat 25, the feed table 26, and the feed table elevating mechanism 27). However, the configuration of the material feed device is not limited to such a configuration. For example, the material feed device may also include a member that stores the powder material 100 above the feed table 26 and causes the powder material 100 to drop onto the feed table 26 from above. In addition, the “re-coater” that levels off the powder material 100 to form the powder layer 102 may not necessarily be the roller 61, but may be, for example, a squeegee. When the “re-coater” is one that does not rotate, the “re-coater” and the powder spread guide may be integrally formed, or be in contact with each other. Further, the relative movement between the feed vat 25 and the layer formation mechanism 60 may be carried out differently, so either one may be transferred in any direction. For example, the layer formation mechanism 60 may be moved while the feed vat 25 is immovable. Still more, in the technology disclosed herein, all the movements of the parts are relative, and the parts that are actually moved are not limited to specific parts.

In the foregoing preferred embodiments, the sub-scanning-direction transfer mechanism 30 and the main-scanning-direction transfer mechanism 50 are used to adjust the position of the solidifying liquid to be ejected. However, it is also possible to use what is called a line head system so that either one of the sub-scanning-direction transfer mechanism 30 and the main-scanning-direction transfer mechanism 50 is used to adjust the position of the solidifying liquid to be ejected. Moreover, the powder material 100 may not necessarily be solidified by ejecting a solidifying liquid thereto, and any method may be used to solidify the powder material 100. Various known techniques may be used, such as sintering by laser application, for example.

The three-dimensional printing apparatus 10 according to the foregoing preferred embodiments is provided with two powder spread guides, the left-side powder spread guide 70L and the right-side powder spread guide 70R, but this is merely an example. The three-dimensional printing apparatus disclosed herein does not exclude a preferred embodiment that includes only one powder spread guide or a preferred embodiment that includes three or more powder spread guides.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing apparatus comprising:
a build vat including a build region in which a three-dimensional object is to be formed, the build vat being capable of containing a powder material therein;
a material feed device that feeds the powder material to the build vat; and
a solidifying device that solidifies the powder material in the build region; wherein
the material feed device includes:
a feed table arrayed with the build vat along a first direction, and including a feed region in which the powder material is to be placed;
a re-coater extending in a second direction perpendicular or substantially perpendicular the first direction, and including a leveler that levels off the powder material;
a powder spread guide including a contact surface that contacts with the powder material; and
a transfer mechanism that transfers the re-coater and the powder spread guide along the first direction from a position above the feed table to a position above the build vat;
the transfer mechanism retains the re-coater so that, in transferring the re-coater, a lower end of the leveler is kept at a first height that is lower than a height of the powder material placed on the feed region;
the transfer mechanism retains the powder spread guide so that, in transferring the powder spread guide, a lowermost end of the contact surface is kept at a second height that is lower than the height of the powder material placed on the feed region, that the contact surface is positioned forward along the first direction relative to the leveler, and that at least a portion of the contact surface passes outside the build region with respect to the second direction; and
the contact surface transfers at least a portion of the powder material that makes contact with the contact surface to an inside of the build region in transferring the powder spread guide.

2. The three-dimensional printing apparatus according to claim 1, wherein
a dimension of the feed region along the second direction is longer than a dimension of the build region along the second direction; and
the transfer mechanism retains the powder spread guide so that, in transferring the powder spread guide, at least a portion of the contact surface passes over a region that is outside the build region and inside the feed region with respect to the second direction.

3. The three-dimensional printing apparatus according to claim 2, wherein
the contact surface includes a first guide surface; and
at least a portion of the first guide surface passes outside the build region with respect to the second direction and faces forwardly substantially along the first direction.

4. The three-dimensional printing apparatus according to claim 3, wherein the first guide surface is a vertical surface.

5. The three-dimensional printing apparatus according to claim 3, wherein, when viewed in plan, the first guide surface is increasingly inclined toward the inside of the build region as the first guide surface extends more rearward along the first direction.

6. The three-dimensional printing apparatus according to claim 3, wherein
the build region includes a first boundary line extending along the first direction;
the first guide surface includes an inner edge extending along the first direction; and
in transferring the powder spread guide, the inner edge of the first guide surface passes on and along the first boundary line.

7. The three-dimensional printing apparatus according to claim 3, wherein
the contact surface includes a second guide surface; and
the second guide surface is positioned outward of the build region relative to the first guide surface with respect to the second direction, the second guide surface protruding forward along the first direction relative to the first guide surface and facing toward the inside of the build region with respect to the second direction.

8. The three-dimensional printing apparatus according to claim 7, wherein
the feed region includes a second boundary line extending along the first direction; and
in transferring the powder spread guide, the second guide surface passes on and along the second boundary line.

9. The three-dimensional printing apparatus according to claim 1, wherein
the feed region includes a second boundary line extending along the first direction;
the contact surface includes a scattering prevention surface facing inward of the build region; and
in transferring the powder spread guide, the scattering prevention surface passes on and along the second boundary line.

10. The three-dimensional printing apparatus according to claim 1, wherein the second height is equal to the first height.

11. The three-dimensional printing apparatus according to claim 1, wherein the transfer mechanism includes:
a retaining member retaining the re-coater and the powder spread guide; and
a driver causing the retaining member to be kept at a predetermined height and to transfer in the first direction.

12. The three-dimensional printing apparatus according to claim 1, wherein the material feed device includes:
a tubular feed vat accommodating the feed table; and
a feed table elevating mechanism supporting the feed table and causing the feed table to ascend and descend in the feed vat.
